(19) United States
(12) Patent Application Publication
(10) Pub. No.: US 2009/0165351 A1
(43) Pub. Date: Jul. 2, 2009

(54) Digital photo frame with exchangeable covers

(76) Inventor: Chun Chieh Hsu, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/003,399

(22) Filed: Dec. 26, 2007

(51) Int. Cl. G09F 9/35

(52) U.S. Cl. 40/799; 40/463

(57) ABSTRACT

A kind of digital photo frame with exchangeable covers includes a LCD (liquid crystal display) and an external panel frame. Several groups of tabling grooves are set on the surface portions of the external frames to provide relative snap-fit portions of the inner side faces of those covers and the easy snapping positioning. And, those covers can be changed at will to provide the digital photo frames with versatility and fitness thus the need of users ate satisfied.

### FIELD OF THE INVENTION

The present invention is related to a kind of digital photo frame with exchangeable covers. By easily changeable covers, the digital photo frames can increase their versatility and raise the total practical values while being used.

### BACKGROUND OF THE INVENTION

The digital photo frame is a recent innovative product that utilizes the application and processing of digital data to create a structural change in viewing the known typed photo storage. It uses a LCD (liquid crystal display) to play the stored digital image data. By only inserting in the memory, the unlimited images can be played in the display of the digital photo frame. However, the current known digital photo frames all have the fixed shape and with no variability. Thus, it cannot satisfy effectively the need of different users and the mood while being used.

### SUMMARY OF THE INVENTION

Therefore, the main object of the present invention is to provide a kind of digital photo frame with exchangeable covers. The designed cover can be changed easily in order that the digital photo frames can show different styles of appearances thus the effects of increasing satisfaction of different customers are achieved. The characteristics and effects of the present invention will be described hereafter by referring to drawings

### BRIEF DESCRIPTION OF THE DRAWINGS

FIG. 1 is a three-dimensional drawing of the present invention.

FIG. 2 is an analytic drawing of FIG. 1.

FIG. 3 is an outside appearance drawing of the present invention while exchanging the cover.

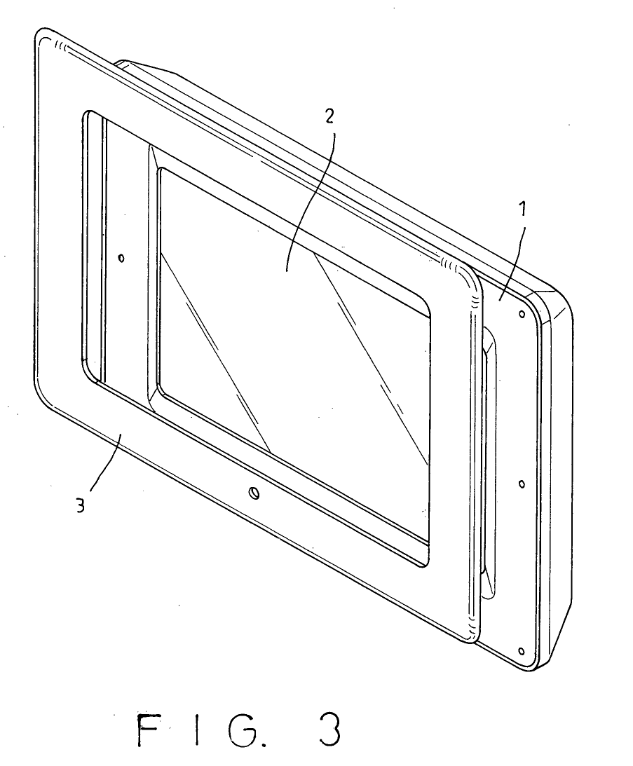

FIG. 4A˜4C are zoom-in explanatory drawings of the present invention while executing the changing of the cover.

FIG. 5 is an outside appearance drawing of the present invention while exchanging another cover.

### DETAILED DESCRIPTION OF THE PREFERRED EMBODIMENT

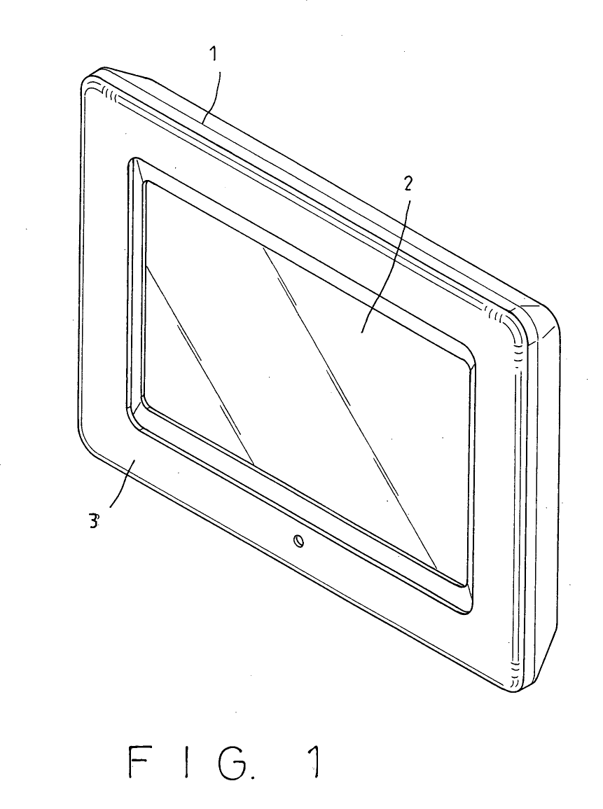

Please refer to the FIGS. 1˜3 firstly. The present invention includes an external panel frame (1) where an LCD (liquid crystal display) (2) is assembled in it, and a cover (3). Wherein at least two tabling grooves (11) are set on the surface portions of the external frames (1) and same numbers of snap-fit portions with are set in the inner side face of that cover (3). Every snap-fit portion (31) can be clip-fit easily to the tabling grooves (11) to assemble and position the cover (3) outside the external frame (1). The surfaces of the covers (3) are set with specific colors and patters, and the digital photo frames with different styles of outside appearances can be shown.

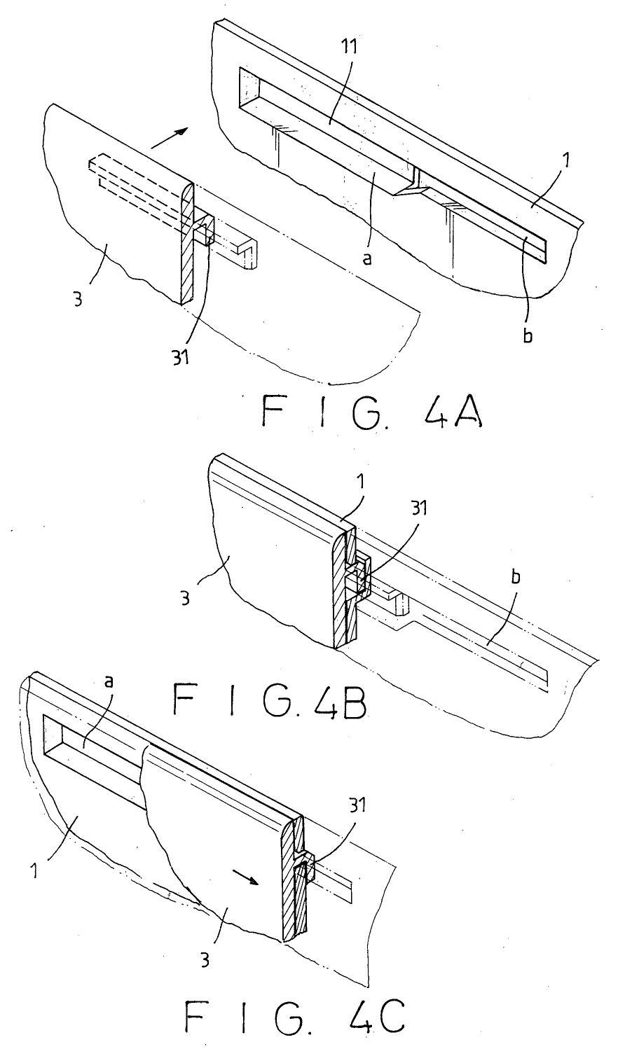

Please refer to the FIG. 4 shown. It is an embodiment of the present invention wherein the snap-fit grooves (11) of surface portions of the external frame (1) are equipped with a larger porthole portion (a) and a thinner long groove portion (b), and the snap-fit portions (31) of the cover (3) is equipped with a L shaped section whose length is smaller or equal to that of the porthole portion (a). Its assembling method is to put the snap-fit portion (31) into the interior space of the porthole (a) as shown in FIG. 4A to 4B, then move integrally toward the long groove portion (b) to form a snap-fit status for the L shaped section as shown in FIG. 4C.

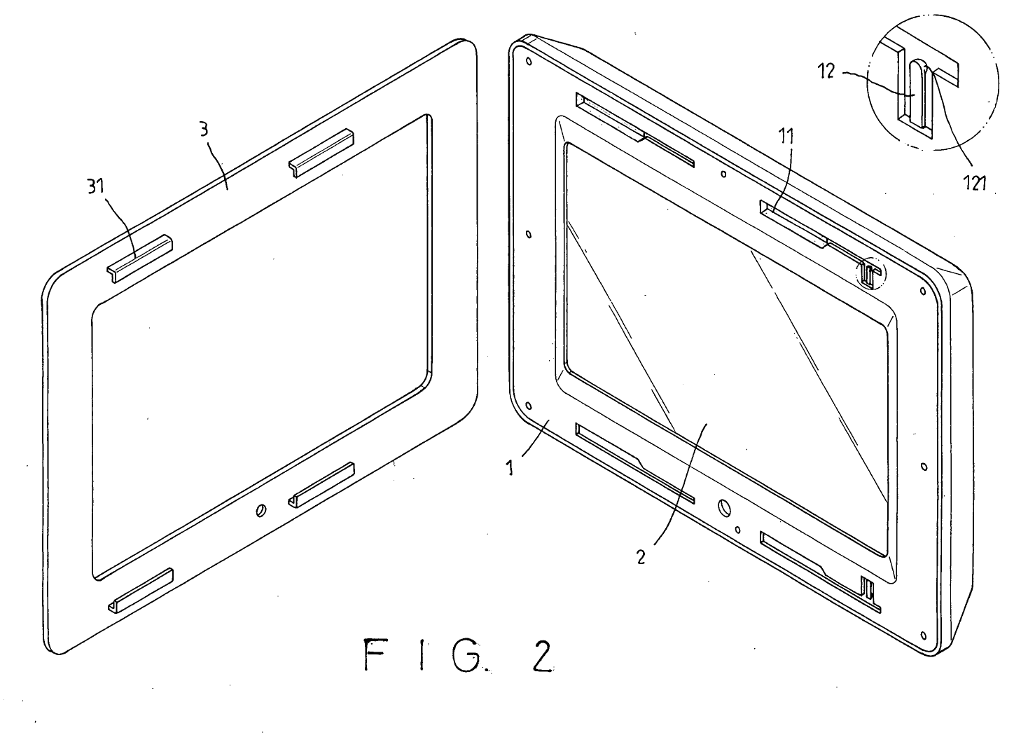

Furthermore, an elastic plate (12) whose inner end is equipped with a round protruded portion (121) can be set to the side of the tail end in the long groove portion (b) as shown in zoom-in drawing of the FIG. 2. While the snap-fit portion (31) moves complete to the position in the long groove portion (b), it will touch with the round protrusion portion (121), push outward the elastic plate (12) and touch closely with the inner side of the cover (3) to form a close snap positioning effect

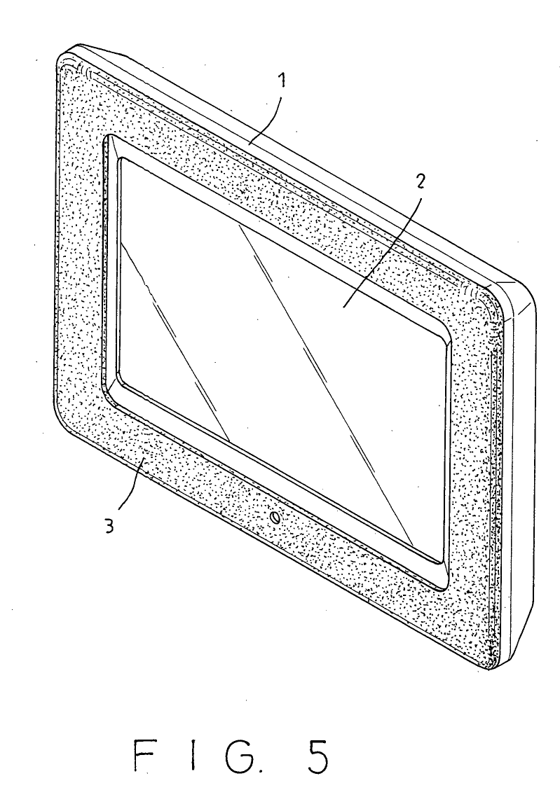

By summarizing the aforementioned description, the present invention can snap-fit and position the cover (3) easily to the external frame (1). Also, the cover (3) can be removed in reverse way quickly and easily. By supplying with different covers (3), the digital photo frames can be in renewal status as shown in FIG. 5. Thus, the covers can be changed according to the need of users to achieve the increasing practicability and advancement. And, the present invention should have conformed to the requirement for patent approval.

I claim:

1. A kind of digital photo frame with exchangeable covers including an external panel frame where a LCD (liquid crystal display) being assembled in it, and a cover, wherein at least two tabling grooves being set on the surface portions of the external frames and same numbers of snap-fit portions with being set in the inner side face of that cover, every snap-fit portion being capable of clip-fit easily to the tabling grooves to assemble and position the cover outside the external frame.

2. A kind of digital photo frame with exchangeable covers as claimed in claim 1, wherein the surfaces of the covers are set with specific colors and patters, the user can change different covers on the external frame at will, and digital photo frames with different styles of outside appearances can be shown.

3. A kind of digital photo frame with exchangeable covers as claimed in claim 1, wherein the snap-fit grooves of surface portions of the external frame are equipped with a larger porthole portion and a thinner long groove portion, and the snap-fit portions of the cover is equipped with a L shaped section whose length is smaller or equal to that of the porthole portion, and the snap-fit portion can be put into the interior space of the porthole then move integrally toward the long groove portion to form a snap-fit status for the L shaped section.

4. A kind of digital photo frame with exchangeable covers as claimed in claim 1, wherein the side of the tail end in the long groove portion is set with an elastic plate whose inner end is equipped with a round protruded portion.

5. A kind of digital photo frame with exchangeable covers as claimed in claim 1, wherein the top and bottom of the surface portion in the external frame is set with two groups of reverse snap-fit grooves and the inner side of the cover is set with four relative snap-fit portions.
